(19) United States
(12) Patent Application Publication
(10) Pub. No.: US 2025/0209577 A1
(43) Pub. Date: Jun. 26, 2025

(54) UPSAMPLING FILTER FOR APPLYING A PREDICTED AVERAGE MODIFICATION

(71) Applicant: V-NOVA INTERNATIONAL LIMITED, London (GB)

(72) Inventor: Max ELLIOT, London (GB)

(21) Appl. No.: 18/851,636

(22) PCT Filed: Mar. 29, 2023
(86) PCT No.: PCT/GB2023/050816

§ 371 Date: Sep. 26, 2024

(30) Foreign Application Priority Data
Mar. 29, 2022 (GB) 2204404.4

(51) Int. Cl. G06T 5/60; G06T 3/4092; G06T 5/20; G06T 5/50; H04N 19/117; H04N 19/176; H04N 19/196; H04N 19/33

(52) U.S. Cl. CPC G06T 5/60; G06T 3/4092; G06T 5/20; G06T 5/50; H04N 19/117; H04N 19/176; H04N 19/198; H04N 19/33; G06T 2207/10021; G06T 2207/20016; G06T 2207/20081

(57) ABSTRACT

An upsampling filter for video coding is described. The upsampling filter is configured to upsample an input frame of video from a first resolution to a second resolution, the second resolution being higher than the first resolution. The upsampling filter has a set of filter coefficients that are configured to modify the output of the upsampling filter to apply a predicted average modifier. In examples, the predicted average modifier is defined as a difference between an average of a data block of pixels at the second resolution following application of the upsampling filter and a corresponding pixel value at the first resolution before application of the upsampling filter.

### TECHNICAL FIELD

The present invention relates to upsampling for video coding. In particular, examples relate to an upsampling filter that modifies a frame of video to apply a predicted average modification that increases an efficiency of an encoding of residual data derived from the frame of video.

### BACKGROUND

EP 2850829 B1 describes a method of transforming element information, such as residual data, to allow for efficient video encoding. In particular, EP 2850829 B1 describes how a directional decomposition may be applied to small blocks of residual data and how an average of a given data block may be adjusted using a so-called “predicted average” to derive sets of transformed residual data for further entropy encoding and transmission or storage as an encoded bit stream. In the examples described therein, the predicted average is determined as a difference between a pixel value at a first, lower resolution and an average of a set of upsampled pixels at a second, higher resolution, where the set of upsampled pixels correspond to an upsampling of the pixel value. The use of a predicted average allows an energy of the average component within the transformed residual data to be reduced, leading to a smaller bitstream and a more efficient encoding.

Within examples of EP 2850829 B1, during decoding of a frame of video, an estimate of the predicted average is computed using signal information available to a decoder. Hence, the predicted average does not need to be explicitly transmitted within a bitstream. In particular, a pixel value at the first, lower resolution may be derived from a first encoded bitstream (e.g., a first layer of encoding) and an average of a set of upsampled pixels at a second, higher resolution may be derived from an upsampling performed at the decoder. In examples of EP 2850829 B1, the predicted average is added to a received delta or adjusted average component of a data block of decoded transformed residuals to restore the original average value for the data block. The data block may then be recomposed (e.g., via application of an inverse directional decomposition) to obtain residual values for the data block. These residual values may then be added to an upsampling of a decoding of the first encoded bitstream to output a decoding of a video signal at the second, higher resolution.

WO2020/188242 A1 describes a form of modified upsampling whereby, during decoding of a video signal, a predicted average modifier may be computed and added to an output of an upsampled signal. In this case, rather than compute the predicted average as part of a decoding process for a layer of an encoded bitstream and apply the predicted average to restore the average component prior to an inverse directional decomposition, the predicted average is computed using an input and an output of an upsampling stage. It is possible to apply the predicted average after upsampling rather than as part of the decoding process due to the primarily linear sequence of decoding operations (e.g., whereby an operation may be moved within the sequence of decoding operation without detrimental effects). The approach of WO2020/188242 A1 allows a more efficient decoding as it avoids needing to apply the inverse directional decomposition to the predicted average component thus saving computational resources and increasing a speed of decoding (e.g., by reducing a number of operations). For example, maintaining transformed adjusted average components of zero across the data blocks during the inverse directional decomposition can reduce the number of bit operations (even if not all adjusted components are zero).

While applying the predicted average modification of EP 2850829 B1 increases encoding efficiencies for the resulting bitstream and moving the application of the modification in WO2020/188242 A1 increases decoding efficiencies, computation and application of a predicted average may add complexity to the encoding and decoding processes. This is especially a problem for older so-called “legacy” hardware devices, such as set-top boxes or built-in decoders. For example, it may be difficult to support the use of the predicted average modification due to hardware constraints at one or more of the encoder and the decoder. In these cases, video distributors may choose to turn off the predicted average functionality and trade-off a less compressed bitstream for wider legacy device support.

Within the art of video coding, there is always a desire for more efficient video coding, for example video coding that reduces a bit-rate of a bitstream for a given decoded video quality and/or that reduces computation or power consumption. Video coding is typically a resource heavy operation involving hardware accelerators for common video coding standards. This also presents a problem of improving video coding efficiencies whilst maintaining support for older hardware devices.

### SUMMARY

Aspects and variations of the present invention are set out in the appended claims.

Certain unclaimed aspects are further set out in the detailed description below.

### BRIEF DESCRIPTION OF FIGURES

FIG. 1 shows a high-level schematic of a hierarchical encoding and decoding process.

FIG. 2 shows a high-level schematic of a hierarchical deconstruction process.

FIG. 3 shows an alternative high-level schematic of a hierarchical deconstruction process.

FIG. 4 shows a high-level schematic of an encoding process suitable for encoding the residuals of tiered outputs.

FIG. 5 shows a high-level schematic of a hierarchical decoding process suitable for decoding each output level from FIG. 4.

FIG. 6 shows a high-level schematic of an encoding process of a hierarchical coding technology.

FIG. 7 shows a high-level schematic of a decoding process suitable for decoding the output of FIG. 6.

FIG. 8 shows an example method of upsampling.

FIGS. 9A to 9C show an example separable five-tap filter for upsampling and example constraints for designing a predicted-average-preserving upsampling filter.

FIG. 10 shows an example of a set of non-predicted-average-preserving upsampling filters that are converted according to the methods described herein into predicted-average-preserving upsampling filters.

FIG. 11 shows an example training configuration for training a predicted-average-preserving upsampling filters.

### DETAILED DESCRIPTION

Certain examples described herein relate to an adapted upsampling operation that may be used, for example, in video coding. In particular, certain examples described herein apply a predicted average computation, such as that described in EP 2850829 B1 or WO2020/188242 A1, as part of an upsampling operation. This is achieved by configuring a set of upsampling coefficients of an upsample filter. For example, a set of upsampling coefficients of an upsample filter may be optimised such that the upsampling operation provides an upsampling of pixel data that reduces a bit-rate of a residual data stream and an output that is equivalent to the modified upsampled output described in WO2020/188242 A1. This may be achieved by configuring the upsampling coefficients such that an average of the pixel values of an upsampled data block (e.g., a 2×2 or 4×4 data block for a particular luma or chroma plane) equals or approximately equals (e.g., within a quantisation tolerance) a pixel value being upsampled to generate the upsampled data block. This then effectively sets a predicted average modifier to be zero, such that, within a transformed residual data block, an average component is the same as an adjusted average component.

The adapted upsampling operation described in examples herein may be used at one or more of an encoder and a decoder. In one case, the adapted upsampler of the examples may be applied at both the encoder and the decoder, e.g. to respectively generate new encoded bitstreams and decode those bit-streams.

In certain specific examples, the adapted upsampling operation is implemented as a separable filter having less than five coefficients for each of the two image dimensions, e.g. as a four-tap separable filter. In examples, a general form of the upsampling coefficients is described that provide the adapted upsampling operation. Hence, different existing upsampling filters may be adapted to provide the predicted average computation. This means that legacy hardware devices, such as set-top boxes, that are restricted to hardware-implemented filters with four coefficients, may apply the predicted average computation in a computationally efficient manner. In cases where more than four coefficients are available for use, one-dimensional filters with five or more coefficients may be used. This may be preferred where there are fewer hardware limitations for a more expressive upsampling filter that further reduces a bit-rate of residual data.

Certain examples described herein may be implemented as part of an MPEG 5, Part 2, Low Complexity Enhancement Video Coding (LCEVC) implementation and/or a SMPTE VC-6 2117 implementation.

In the text below, certain features of example signal encoders and decoders are first described. These example signal encoders and decoders may use an adapted upsampling operation as described herein. Following this general description, certain specific aspects of the adapted upsampling operation will be described in detail. The adapted upsampling operation is more easily understood having first understood examples of a tier-based hierarchical coding scheme or format that uses upsampling, although the approaches described in the later examples need not be limited to such schemes.

### General Signal Processing Terms and Definitions

Examples described herein relate to signal processing. A signal may be considered as a sequence of samples (i.e., two-dimensional images, video frames, video fields, sound frames, etc.). In the description, the terms “image”, “picture” or “plane” (intended with the broadest meaning of “hyperplane”, i.e., array of elements with any number of dimensions and a given sampling grid) will be often used to identify the digital rendition of a sample of the signal along the sequence of samples, wherein each plane has a given resolution for each of its dimensions (e.g., X and Y), and comprises a set of plane elements (or “element”, or “pel”, or display element for two-dimensional images often called “pixel”, for volumetric images often called “voxel”, etc.) characterized by one or more “values” or “settings” (e.g., by ways of non-limiting examples, colour settings in a suitable colour space, settings indicating density levels, settings indicating temperature levels, settings indicating audio pitch, settings indicating amplitude, settings indicating depth, settings indicating alpha channel transparency level, etc.). Each plane element is identified by a suitable set of coordinates, indicating the integer positions of said element in the sampling grid of the image. Signal dimensions can include only spatial dimensions (e.g., in the case of an image) or also a time dimension (e.g., in the case of a signal evolving over time, such as a video signal).

As examples, a signal can be an image, an audio signal, a multi-channel audio signal, a telemetry signal, a video signal, a 3DoF/6DoF video signal, a volumetric signal (e.g., medical imaging, scientific imaging, holographic imaging, etc.), a volumetric video signal, or even signals with more than four dimensions.

For simplicity, examples described herein often refer to signals that are displayed as 2D planes of settings (e.g., 2D images in a suitable colour space), such as for instance a video signal. The terms “frame” or “field” will be used interchangeably with the term “image”, so as to indicate a sample in time of the video signal: any concepts and methods illustrated for video signals made of frames (progressive video signals) can be easily applicable also to video signals made of fields (interlaced video signals), and vice versa. Despite the focus of embodiments illustrated herein on image and video signals, people skilled in the art can easily understand that the same concepts and methods are also applicable to any other types of multidimensional signal (e.g., audio signals, volumetric signals, stereoscopic video signals, 3DoF/6DoF video signals, plenoptic signals, point clouds, etc.).

Certain tier-based hierarchical formats described herein use a varying amount of correction (e.g., in the form of also “residual data”, or simply “residuals”) in order to generate a reconstruction of the signal at the given level of quality that best resembles (or even losslessly reconstructs) the original. The amount of correction may be based on a fidelity of a predicted rendition of a given level of quality.

In order to achieve a high-fidelity reconstruction, coding methods may upsample a lower resolution reconstruction of the signal to the next higher resolution reconstruction of the signal. In certain case, different signals may be best processed with different methods, i.e., a same method may not be optimal for all signals.

### Examples of a Tier-Based Hierarchical Coding Scheme or Format

In preferred examples, encoders or decoders are part of a tier-based hierarchical coding scheme or format. Examples of a tier-based hierarchical coding scheme include LCEVC: MPEG-5 Part 2 LCEVC and VC-6: SMPTE VC-6 ST-2117, the former being described in PCT/GB2020/050695 (and the associated standard document) and the latter being described in PCT/GB2018/053552 (and the associated standard document), all of which are incorporated by reference herein. However, the concepts illustrated herein need not be limited to these specific hierarchical coding schemes.

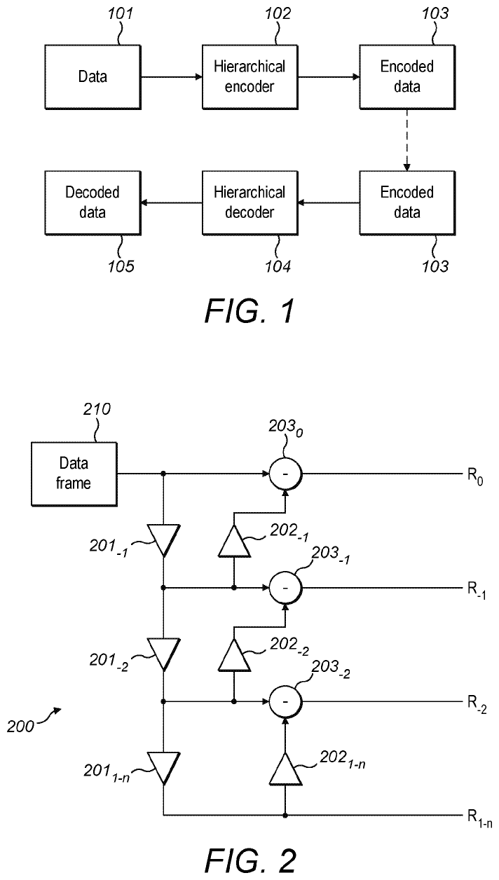

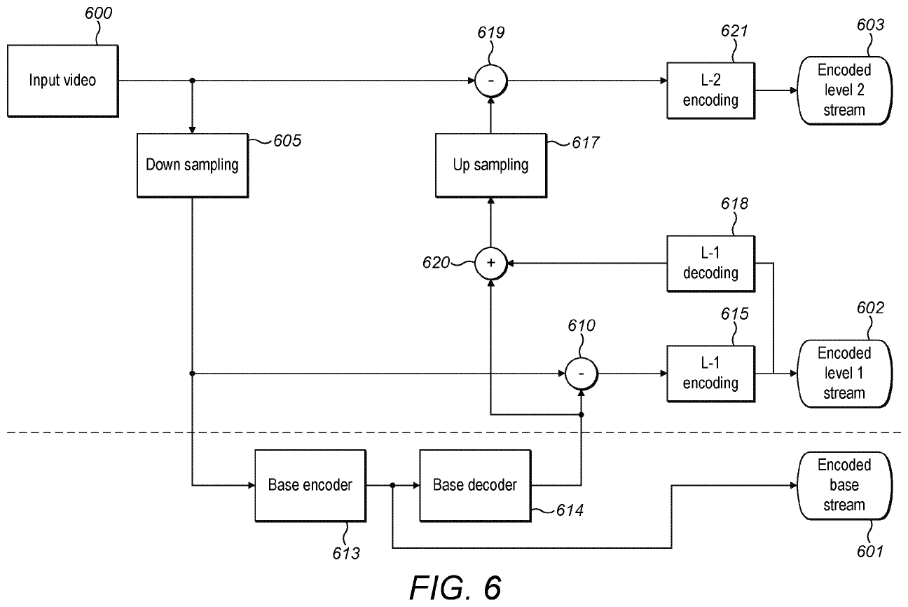

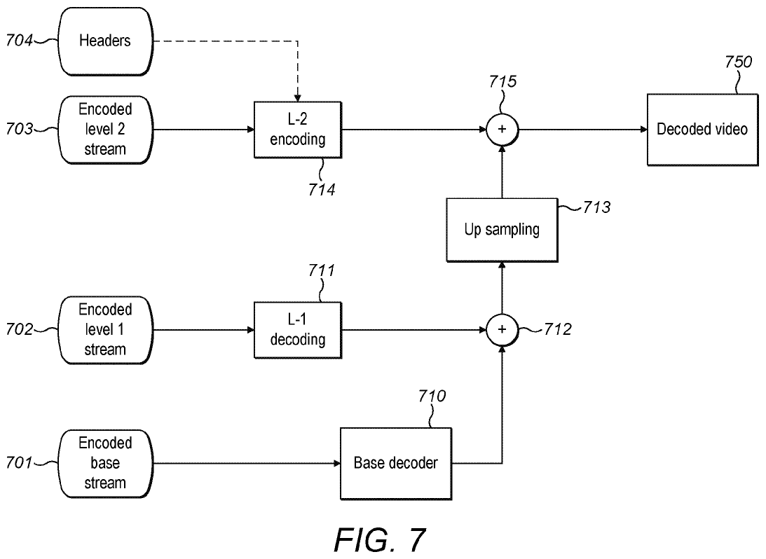

FIGS. 1 to 7 provide an overview of different example tier-based hierarchical coding formats. These are provided as context for the adapted upsampling operations, which are set out in the Figures following FIG. 7. FIGS. 1 to 5 provide examples similar to the implementation of SMPTE VC-6 ST-2117, whereas FIGS. 6 and 7 provide examples similar to the implementation of MPEG-5 Part 2 LCEVC. It may be seen that both sets of examples utilise common underlying operations (e.g., downsampling, upsampling and residual generation) and may share modular implementing technologies.

### General Hierarchical Coding Scheme

FIG. 1 illustrates, very generally, a hierarchical coding scheme. Data to be encoded 101 is retrieved by a hierarchical encoder 102 which outputs encoded data 103. Subsequently, the encoded data 103 is received by a hierarchical decoder 104 which decodes the data and outputs decoded data 105.

Typically, the hierarchical coding schemes used in examples herein create a base or core level, which is a representation of the original data at a lower level of quality and one or more levels of residuals which can be used to recreate the original data at a higher level of quality using a decoded version of the base level data. In general, the term “residuals” as used herein refers to a difference between a value of a reference array or reference frame and an actual array or frame of data. The array may be a one or two-dimensional array that represents a coding unit. For example, a coding unit may be a 2×2 or 4×4 set of residual values that correspond to similar sized areas of an input video frame.

It should be noted that the generalised examples are agnostic as to the nature of the input signal. Reference to “residual data” as used herein refers to data derived from a set of residuals, e.g. a set of residuals themselves or an output of a set of data processing operations that are performed on the set of residuals. Throughout the present description, generally a set of residuals includes a plurality of residuals or residual elements, each residual or residual element corresponding to a signal element, that is, an element of the signal or original data.

In specific examples, the data may be an image or video. In these examples, the set of residuals corresponds to an image or frame of the video, with each residual being associated with a pixel of the signal, the pixel being the signal element.

The methods described herein may be applied to so-called planes of data that reflect different colour components of a video signal. For example, the methods may be applied to different planes of YUV or RGB data reflecting different colour channels. Different colour channels may be processed in parallel. The components of each stream may be collated in any logical order.

### First Example Hierarchical Encoder & Components

A hierarchical coding scheme will now be described in which the concepts of the invention may be deployed. The scheme is conceptually illustrated in FIGS. 2 to 5 and corresponds generally to VC-6 described above. In such encoding techniques, residuals data is used in progressively higher levels of quality. In this proposed technique, a core layer represents the image at a first resolution and subsequent layers in the tiered hierarchy are residual data or adjustment layers necessary for the decoding side to reconstruct the image at a higher resolution. Each layer or level may be referred to as an echelon index, such that the residuals data is data required to correct low quality information present in a lower echelon index. Each layer or echelon index in this hierarchical technique, particularly each residual layer, is often a comparatively sparse data set having many zero value elements. When reference is made to an echelon index, it refers collectively to all echelons or sets of components at that level, for example, all subsets arising from a transform step performed at that level of quality.

In this particular hierarchical manner, the described data structure removes any requirement for, or dependency on, the preceding or proceeding level of quality. A level of quality may be encoded and decoded separately, and without reference to any other layer. Thus, in contrast to many known other hierarchical encoding schemes, where there is a requirement to decode the lowest level of quality in order to decode any higher levels of quality, the described methodology does not require the decoding of any other layer. Nevertheless, the principles of exchanging information described below may also be applicable to other hierarchical coding schemes.

As shown in FIG. 2, the encoded data represents a set of layers or levels, generally referred to here as echelon indices. The base or core level represents the original data frame 210, albeit at the lowest level of quality or resolution and the subsequent residuals data echelons can combine with the data at the core echelon index to recreate the original image at progressively higher resolutions.

To create the core-echelon index, an input data frame 210 may be down-sampled using a number of down-sampling operations 201 corresponding to the number of levels or echelon indices to be used in the hierarchical coding operation. One fewer down-sampling operation 201 is required than the number of levels in the hierarchy. In all examples illustrated herein, there are 4 levels or echelon indices of output encoded data and accordingly 3 down-sampling operations, but it will of course be understood that these are merely for illustration. Where n indicates the number of levels, the number of down-samplers is n−1. The core level R₁₋ₙ is the output of the third down-sampling operation. As indicated above, the core level R₁₋ₙ corresponds to a representation of the input data frame at a lowest level of quality.

To distinguish between down-sampling operations 201, each will be referred to in the order in which the operation is performed on the input data 210 or by the data which its output represents. For example, the third down-sampling operation 201₁₋ₙ in the example may also be referred to as the core down-sampler as its output generates the core-echelon index or echelon₁₋ₙ, that is, the index of all echelons at this level is 1-n. Thus, in this example, the first down-sampling operation 201₋₁ corresponds to the R₋₁ down-sampler, the second down-sampling operation 201₋₂ corresponds to the R₋₂ down-sampler and the third down-sampling operation 201₁₋ₙ corresponds to the core or R₋₃ down-sampler.

As shown in FIG. 2, the data representing the core level of quality R₁₋ₙ undergoes an up-sampling operation 202₁₋ₙ, referred to here as the core up-sampler. A difference 203₋₂ between the output of the second down-sampling operation 201₋₂ (the output of the R₋₂ down-sampler, i.e. the input to the core down-sampler) and the output of the core up-sampler 202₁₋ₙ is output as the first residuals data R₋₂. This first residuals data R₋₂ is accordingly representative of the error between the core level R₋₃ and the signal that was used to create that level. Since that signal has itself undergone two down-sampling operations in this example, the first residuals data R₋₂ is an adjustment layer which can be used to recreate the original signal at a higher level of quality than the core level of quality but a lower level than the input data frame 210.

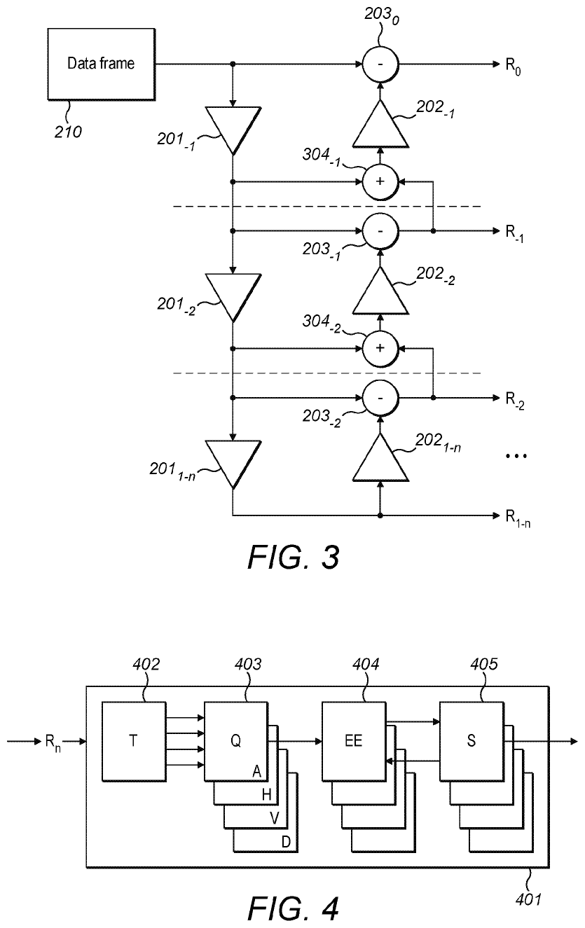

Variations in how to create residuals data representing higher levels of quality are conceptually illustrated in FIGS. 2 and 3.

In FIG. 2, the output of the second down-sampling operation 201₋₂ (or R₋₂ down-sampler, i.e. the signal used to create the first residuals data R₋₂), is up-sampled 202₋₂ and the difference 203₋₁ between the input to the second down-sampling operation 201₋₂ (or R₋₂ down-sampler, i.e. the output of the R₋₁ down-sampler) is calculated in much the same way as the first residuals data R₋₂ is created. This difference is accordingly the second residuals data R₋₁ and represents an adjustment layer which can be used to recreate the original signal at a higher level of quality using the data from the lower layers.

In the variation of FIG. 3, however, the output of the second down-sampling operation 201₋₂ (or R₋₂ down-sampler) is combined or summed 304₋₂ with the first residuals data R₋₂ to recreate the output of the core up-sampler 202₁₋ₙ. In this variation it is this recreated data which is up-sampled 202₋₂ rather than the down-sampled data. The up-sampled data is similarly compared 203₋₁ to the input to the second down-sampling operation (or R₋₂ down-sampler, i.e. the output of the R₋₁ down-sampler) to create the second residuals data R₋₁.

The variation between the implementations of FIGS. 2 and 3 results in slight variations in the residuals data between the two implementations. FIG. 2 benefits from greater potential for parallelisation.

The process or cycle repeats to create the third residuals R₀. In the examples of FIGS. 2 and 3, the output residuals data R₀ (i.e. the third residuals data) corresponds to the highest level and is used at the decoder to recreate the input data frame. At this level the difference operation is based on the input data frame which is the same as the input to the first down-sampling operation.

FIG. 4 illustrates an example encoding process 401 for encoding each of the levels or echelon indices of data to produce a set of encoded echelons of data having an echelon index. This encoding process is used merely for example of a suitable encoding process for encoding each of the levels, but it will be understood that any suitable encoding process may be used. The input to the process is a respective level of residuals data output from FIG. 2 or 3 and the output is a set of echelons of encoded residuals data, the echelons of encoded residuals data together hierarchically represent the encoded data.

In a first step, a transform 402 is performed. The transform may be directional decomposition transform as described in WO2013/171173. If a directional decomposition transform is used, there may be output a set of four components (also referred to as transformed coefficients). For example, a 2×2 data block may be transformed to generate four components: three directional components approximately related to horizontal, vertical, and diagonal directions within the data block and an average component representing an aggregate computation applied to the whole data block. When reference is made to an echelon index, it refers collectively to all directions, e.g., 4 echelons. For example, a 2×2 data block may be flattened as a 4×1 set of values and then transformed using a 4×4 Hadamard transform. In certain cases, a normalising factor (e.g., ¼ is omitted for the transform as normalisation is implicitly applied via other processing such as quantisation or entropy encoding). An average component may thus be generated for a 2×2 data block by summing the individual residual values in the data block (e.g., multiplying by the Hadamard row {1, 1, 1, 1}). The average component may further be adjusted by subtracting a “predicted average”. This is described in detail EP 2850829 B1. In summary, the predicted average is a difference between a lower tier pixel value and an average of a set of corresponding upper tier upsampled values (e.g., for each output 2×2 data block from upsamplers 202, the input pixel minus the average of the upsampled pixels). As this predicted average can be recovered at the decoder using received data, subtracting the predicted average at the encoder and re-adding the predicted average at the decoder reduces the size of the average component of the transformed data block. In the later examples, a special upsampling operation is applied that may be used by the upsamplers 202 to reduce the size of the average component without explicitly applying the predicted average modification, e.g. where the adapted upsampling operation applies the predicted average modification avoiding the need to subtract the predicted average at the encoder and re-adding at the decoder. Although examples are described with respect to a 2×2 data block, similar approaches may also be applied for larger data blocks (e.g., 4×4 and above), where these data blocks will also have an “average” or “average of average” component.

Returning back to FIG. 4, the component set output by the transform 402 is then quantized 403 before entropy encoding. In this example, the entropy encoding operation 404 is coupled to a sparsification step 405 which takes advantage of the sparseness of the residuals data to reduce the overall data size and involves mapping data elements to an ordered quadtree. Such coupling of entropy coding and sparsification is described further in WO2019/111004 but the precise details of such a process is not relevant to the understanding of the invention. Each array of residuals may be thought of as an echelon.

The process set out above corresponds to an encoding process suitable for encoding data for reconstruction according to SMPTE ST 2117, VC-6 Multiplanar Picture Format. VC-6 is a flexible, multi-resolution, intra-only bitstream format, capable of compressing any ordered set of integer element grids, each of independent size but is also designed for picture compression. It employs data agnostic techniques for compression and is capable of compressing low or high bit-depth pictures. The bitstream's headers can contain a variety of metadata about the picture.

As will be understood, each echelon or echelon index may be implemented using a separate encoder or encoding operation. Similarly, an encoding module may be divided into the steps of down-sampling and comparing, to produce the residuals data, and subsequently encoding the residuals or alternatively each of the steps of the echelon may be implemented in a combined encoding module. Thus, the process may be for example be implemented using 4 encoders, one for each echelon index, 1 encoder and a plurality of encoding modules operating in parallel or series, or one encoder operating on different data sets repeatedly.

### First Example Hierarchical Decoder & Components

The following sets out an example of reconstructing an original data frame, the data frame having been encoded using the above exemplary process. This reconstruction process may be referred to as pyramidal reconstruction. Advantageously, the method provides an efficient technique for reconstructing an image encoded in a received set of data, which may be received by way of a data stream, for example, by way of individually decoding different component sets corresponding to different image size or resolution levels, and combining the image detail from one decoded component set with the upscaled decoded image data from a lower-resolution component set. Thus, by performing this process for two or more component sets, digital images at the structure or detail therein may be reconstructed for progressively higher resolutions or greater numbers of pixels, without requiring the full or complete image detail of the highest-resolution component set to be received. Rather, the method facilitates the progressive addition of increasingly higher-resolution details while reconstructing an image from a lower-resolution component set, in a staged manner.

Moreover, the decoding of each component set separately facilitates the parallel processing of received component sets, thus improving reconstruction speed and efficiency in implementations wherein a plurality of processes is available.

Each resolution level corresponds to a level of quality or echelon index. This is a collective term, associated with a plane (in this example a representation of a grid of integer value elements) that describes all new inputs or received component sets, and the output reconstructed image for a cycle of index-m. The reconstructed image in echelon index zero, for instance, is the output of the final cycle of pyramidal reconstruction.

Pyramidal reconstruction may be a process of reconstructing an inverted pyramid starting from the initial echelon index and using cycles by new residuals to derive higher echelon indices up to the maximum quality, quality zero, at echelon index zero. A cycle may be thought of as a step in such pyramidal reconstruction, the step being identified by an index-m. The step typically comprises up-sampling data output from a possible previous step, for instance, upscaling the decoded first component set, and takes new residual data as further inputs in order to obtain output data to be up-sampled in a possible following step. Where only first and second component sets are received, the number of echelon indices will be two, and no possible following step is present. However, in examples where the number of component sets, or echelon indices, is three or greater, then the output data may be progressively upsampled in the following steps.

The first component set typically corresponds to the initial echelon index, which may be denoted by echelon index 1-N, where N is the number of echelon indices in the plane.

Typically, the upscaling of the decoded first component set comprises applying an upsampler to the output of the decoding procedure for the initial echelon index. In examples, this involves bringing the resolution of a reconstructed picture output from the decoding of the initial echelon index component set into conformity with the resolution of the second component set, corresponding to 2-N. Typically, the upscaled output from the lower echelon index component set corresponds to a predicted image at the higher echelon index resolution. Owing to the lower-resolution initial echelon index image and the up-sampling process, the predicted image typically corresponds to a smoothed or blurred picture.

Adding to this predicted picture higher-resolution details from the echelon index above provides a combined, reconstructed image set. Advantageously, where the received component sets for one or more higher-echelon index component sets comprise residual image data, or data indicating the pixel value differences between upscaled predicted pictures and original, uncompressed, or pre-encoding images, the amount of received data required in order to reconstruct an image or data set of a given resolution or quality may be considerably less than the amount or rate of data that would be required in order to receive the same quality image using other techniques. Thus, by combining low-detail image data received at lower resolutions with progressively greater-detail image data received at increasingly higher resolutions in accordance with the method, data rate requirements are reduced.

Typically, the set of encoded data comprises one or more further component sets, wherein each of the one or more further component sets corresponds to a higher image resolution than the second component set, and wherein each of the one or more further component sets corresponds to a progressively higher image resolution, the method comprising, for each of the one or more further component sets, decoding the component set so as to obtain a decoded set, the method further comprising, for each of the one or more further component sets, in ascending order of corresponding image resolution: upscaling the reconstructed set having the highest corresponding image resolution so as to increase the corresponding image resolution of the reconstructed set to be equal to the corresponding image resolution of the further component set, and combining the reconstructed set and the further component set together so as to produce a further reconstructed set.

In this way, the method may involve taking the reconstructed image output of a given component set level or echelon index, upscaling that reconstructed set, and combining it with the decoded output of the component set or echelon index above, to produce a new, higher resolution reconstructed picture. It will be understood that this may be performed repeatedly, for progressively higher echelon indices, depending on the total number of component sets in the received set.

In typical examples, each of the component sets corresponds to a progressively higher image resolution, wherein each progressively higher image resolution corresponds to a factor-of-four increase in the number of pixels in a corresponding image. Typically, therefore, the image size corresponding to a given component set is four times the size or number of pixels, or double the height and double the width, of the image corresponding to the component set below, that is the component set with the echelon index one less than the echelon index in question. A received set of component sets in which the linear size of each corresponding image is double with respect to the image size below may facilitate more simple upscaling operations, for example.

In the illustrated example, the number of further component sets is two. Thus, the total number of component sets in the received set is four. This corresponds to the initial echelon index being echelon-3.

The first component set may correspond to image data, and the second and any further component sets correspond to residual image data. As noted above, the method provides particularly advantageous data rate requirement reductions for a given image size in cases where the lowest echelon index, that is the first component set, contains a low resolution, or down sampled, version of the image being transmitted. In this way, with each cycle of reconstruction, starting with a low resolution image, that image is upscaled so as to produce a high resolution albeit smoothed version, and that image is then improved by way of adding the differences between that upscaled predicted picture and the actual image to be transmitted at that resolution, and this additive improvement may be repeated for each cycle. Therefore, each component set above that of the initial echelon index needs only contain residual data in order to reintroduce the information that may have been lost in down sampling the original image to the lowest echelon index.

The method provides a way of obtaining image data, which may be residual data, upon receipt of a set containing data that has been compressed, for example, by way of decomposition, quantization, entropy-encoding, and sparsification, for instance. A residual may be a difference between elements of a first image and elements of a second image, typically co-located. Such residual image data may typically have a high degree of sparseness. This may be thought of as corresponding to an image wherein areas of detail are sparsely distributed amongst areas in which details are minimal, negligible, or absent. Such sparse data may be described as an array of data wherein the data are organised in at least a two-dimensional structure (e.g., a grid), and wherein a large portion of the data so organised are zero (logically or numerically) or are considered to be below a certain threshold. Residual data are just one example. Additionally, metadata may be sparse and so be reduced in size to a significant degree by this process. Sending data that has been sparsified allows a significant reduction in required data rate to be achieved by way of omitting to send such sparse areas, and instead reintroducing them at appropriate locations within a received byteset at a decoder.

Typically, the entropy-decoding, de-quantizing, and directional composition transform steps are performed in accordance with parameters defined by an encoder or a node from which the received set of encoded data is sent. For each echelon index, or component set, the steps serve to decode image data so as to arrive at a set which may be combined with different echelon indices as per the technique disclosed above, while allowing the set for each level to be transmitted in a data-efficient manner.

There may also be provided a method of reconstructing a set of encoded data according to the method disclosed above, wherein the decoding of each of the first and second component sets is performed according to the method disclosed above. Thus, the advantageous decoding method of the present disclosure may be utilised for each component set or echelon index in a received set of image data and reconstructed accordingly.

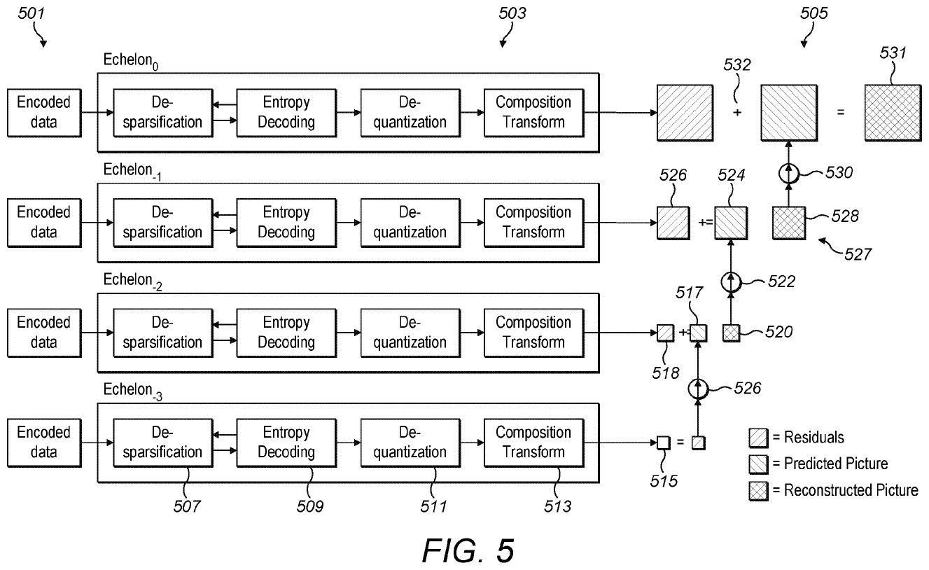

With reference to FIG. 5, a decoding example is now described. A set of encoded data 501 is received, wherein the set comprises four echelon indices, each echelon index comprising four echelons: from echelon₀, the highest resolution or level of quality, to echelon₋₃, the initial echelon. The image data carried in the echelon₋₃ component set corresponds to image data, and the other component sets contain residual data for that transmitted image. While each of the levels may output data that can be considered as residuals, the residuals in the initial echelon level, that is echelon₋₃, effectively correspond to the actual reconstructed image. At stage 503, each of the component sets is processed in parallel so as to decode that encoded set.

With reference to the initial echelon index, or the core-echelon index, the following decoding steps are carried out for each component set echelon₋₃ to echelon₀.

At step 507, the component set is de-sparsified. De-sparsification may be an optional step that is not performed in other tier-based hierarchical formats. In this example, the de-sparsification causes a sparse two-dimensional array to be recreated from the encoded byteset received at each echelon. Zero values grouped at locations within the two-dimensional array which were not received (owing to there being omitted from the transmitted byteset in order to reduce the quantity of data transmitted) are repopulated by this process. Non-zero values in the array retain their correct values and positions within the recreated two-dimensional array, with the de-sparsification step repopulating the transmitted zero values at the appropriate locations or groups of locations there between.

At step 509, a range decoder, the configured parameters of which correspond to those using which the transmitted data was encoded prior to transmission, is applied to the de-sparsified set at each echelon in order to substitute the encoded symbols within the array with pixel values. The encoded symbols in the received set are substituted for pixel values in accordance with an approximation of the pixel value distribution for the image. The use of an approximation of the distribution, that is relative frequency of each value across all pixel values in the image, rather than the true distribution, permits a reduction in the amount of data required to decode the set, since the distribution information is required by the range decoder in order to carry out this step. As described in the present disclosure, the steps of de-sparsification and range decoding are interdependent, rather than sequential. This is indicated by the loop formed by the arrows in the flow diagram.

At step 511, the array of values is de-quantized. This process is again carried out in accordance with the parameters with which the decomposed image was quantized prior to transmission.

Following de-quantization, the set is transformed at step 513 by a composition transform which comprises applying an inverse directional decomposition operation to the de-quantized array. This causes the directional filtering, according to an operator set comprising average or adjusted average, horizontal, vertical, and diagonal operators, to be reversed, such that the resultant array is image data for echelon₋₃ and residual data for echelon₋₂ to echelon₀. As the Hadamard transformation is its own inverse, a common transformation matrix may be applied for both forward and inverse transformations (plus any additional normalisation, however this may be performed implicitly via quantisation). In comparative examples, the inverse directional decomposition may also include added a decoder-computed predicted average to an adjusted average component prior to the inverse transformation. Later examples described herein, provide a way to skip the predicted average adjustment and to apply such an adjustment implicitly via the upsampling operations.

Stage 505 illustrates the several cycles involved in the reconstruction utilising the output of the composition transform for each of the echelon component sets 501. Stage 515 indicates the reconstructed image data output from the decoder 503 for the initial echelon. In an example, the reconstructed picture 515 has a resolution of 64×64. At 516, this reconstructed picture is up-sampled so as to increase its constituent number of pixels by a factor of four, thereby a predicted picture 517 having a resolution of 128×128 is produced. At stage 520, the predicted picture 517 is added to the decoded residuals 518 from the output of the decoder at echelon₋₂. The addition of these two 128×128-size images produces a 128×128-size reconstructed image, containing the smoothed image detail from the initial echelon enhanced by the higher-resolution detail of the residuals from echelon₋₂. This resultant reconstructed picture 519 may be output or displayed if the required output resolution is that corresponding to echelon₋₂. In the present example, the reconstructed picture 519 is used for a further cycle. At step 512, the reconstructed image 519 is up-sampled in the same manner as at step 516, so as to produce a 256×256-size predicted picture 524. This is then combined at step 528 with the decoded echelon₋₁ output 526, thereby producing a 256×256-size reconstructed picture 527 which is an upscaled version of prediction 519 enhanced with the higher-resolution details of residuals 526. At 530 this process is repeated a final time, and the reconstructed picture 527 is upscaled to a resolution of 512×512, for combination with the echelon₀ residual at stage 532. Thereby a 512×512 reconstructed picture 531 is obtained.

In comparative implementations, such as that of EP 2850829 B1, a predicted average may be computed and added as part of step 513. In other comparative implementations, such as WO2020/188242 A1, a predicted average may be added as a modifier after each upsampling step (e.g., one or more of 526, 522 and 530). Use of a predicted average may be a configurable parameter, such that it may be turned on and off and indicated via configuration data in the bitstream. In preferred examples described herein, the predicted average computation is applied implicitly by suitably configuring the coefficients of the upsampling filter that performs the upsampling at one or more of steps 526, 522 and 530. In this case, an average component following transformation may be computed without explicitly applying the predicted average modification but the energy or bit content of the average component is still reduced within the encoded bitstream.

### Second Example Hierarchical Encoder & Components

A further hierarchical coding technology with which the principles of the present invention may be utilised is illustrated in FIGS. 6 and 7. This technology is a flexible, adaptable, highly efficient and computationally inexpensive coding format which combines a different video coding format, a base codec, (e.g., AVC, HEVC, or any other present or future codec) with at least two enhancement levels of coded data.

The general structure of the encoding scheme uses a down-sampled source signal encoded with a base codec, adds a first level of correction data to the decoded output of the base codec to generate a corrected picture, and then adds a further level of enhancement data to an up-sampled version of the corrected picture. Thus, the streams are considered to be a base stream and an enhancement stream, which may be further multiplexed or otherwise combined to generate an encoded data stream. In certain cases, the base stream and the enhancement stream may be transmitted separately. References to an encoded data as described herein may refer to the enhancement stream or a combination of the base stream and the enhancement stream. The base stream may be decoded by a hardware decoder while the enhancement stream may be suitable for software processing implementation with suitable power consumption. This general encoding structure creates a plurality of degrees of freedom that allow great flexibility and adaptability to many situations, thus making the coding format suitable for many use cases including OTT transmission, live streaming, live ultra-high-definition UHD broadcast, and so on. Although the decoded output of the base codec is not intended for viewing, it is a fully decoded video at a lower resolution, making the output compatible with existing decoders and, where considered suitable, also usable as a lower resolution output.

In certain examples, each or both enhancement streams may be encapsulated into one or more enhancement bitstreams using a set of Network Abstraction Layer Units (NALUs). The NALUs are meant to encapsulate the enhancement bitstream in order to apply the enhancement to the correct base reconstructed frame. The NALU may for example contain a reference index to the NALU containing the base decoder reconstructed frame bitstream to which the enhancement has to be applied. In this way, the enhancement can be synchronised to the base stream and the frames of each bitstream combined to produce the decoded output video (i.e. the residuals of each frame of enhancement level are combined with the frame of the base decoded stream). A group of pictures may represent multiple NALUs.

Returning to the initial process described above, where a base stream is provided along with two levels (or sub-levels) of enhancement within an enhancement stream, an example of a generalised encoding process is depicted in the block diagram of FIG. 6. An input video 600 at an initial resolution is processed to generate various encoded streams 601, 602, 603. A first encoded stream (encoded base stream) is produced by feeding a base codec (e.g., AVC, HEVC, or any other codec) with a down-sampled version of the input video. The encoded base stream may be referred to as the base layer or base level. A second encoded stream (encoded level 1 stream) is produced by processing the residuals obtained by taking the difference between a reconstructed base codec video and the down-sampled version of the input video. A third encoded stream (encoded level 2 stream) is produced by processing the residuals obtained by taking the difference between an up-sampled version of a corrected version of the reconstructed base coded video and the input video. In certain cases, the components of FIG. 6 may provide a general low complexity encoder. In certain cases, the enhancement streams may be generated by encoding processes that form part of the low complexity encoder and the low complexity encoder may be configured to control an independent base encoder and decoder (e.g., as packaged as a base codec). In other cases, the base encoder and decoder may be supplied as part of the low complexity encoder. In one case, the low complexity encoder of FIG. 6 may be seen as a form of wrapper for the base codec, where the functionality of the base codec may be hidden from an entity implementing the low complexity encoder.

A down-sampling operation illustrated by down-sampling component 105 may be applied to the input video to produce a down-sampled video to be encoded by a base encoder 613 of a base codec. The down-sampling can be done either in both vertical and horizontal directions, or alternatively only in the horizontal direction. The base encoder 613 and a base decoder 614 may be implemented by a base codec (e.g., as different functions of a common codec). The base codec, and/or one or more of the base encoder 613 and the base decoder 614 may comprise suitably configured electronic circuitry (e.g., a hardware encoder/decoder) and/or computer program code that is executed by a processor.

Each enhancement stream encoding process may not necessarily include an upsampling step. In FIG. 6 for example, the first enhancement stream is conceptually a correction stream while the second enhancement stream is upsampled to provide a level of enhancement.

Looking at the process of generating the enhancement streams in more detail, to generate the encoded Level 1 stream, the encoded base stream is decoded by the base decoder 614 (i.e., a decoding operation is applied to the encoded base stream to generate a decoded base stream). Decoding may be performed by a decoding function or mode of a base codec. The difference between the decoded base stream and the down-sampled input video is then created at a level 1 comparator 610 (i.e., a subtraction operation is applied to the down-sampled input video and the decoded base stream to generate a first set of residuals). The output of the comparator 610 may be referred to as a first set of residuals, e.g. a surface or frame of residual data, where a residual value is determined for each picture element at the resolution of the base encoder 613, the base decoder 614 and the output of the down-sampling block 605.

The difference is then encoded by a first encoder 615 (i.e., a level 1 encoder) to generate the encoded Level 1 stream 602 (i.e., an encoding operation is applied to the first set of residuals to generate a first enhancement stream).

As noted above, the enhancement stream may comprise a first level of enhancement 602 and a second level of enhancement 603. The first level of enhancement 602 may be considered to be a corrected stream, e.g. a stream that provides a level of correction to the base encoded/decoded video signal at a lower resolution than the input video 600. The second level of enhancement 603 may be considered to be a further level of enhancement that converts the corrected stream to the original input video 600, e.g. that applies a level of enhancement or correction to a signal that is reconstructed from the corrected stream.

In the example of FIG. 6, the second level of enhancement 603 is created by encoding a further set of residuals. The further set of residuals are generated by a level 2 comparator 619. The level 2 comparator 619 determines a difference between an upsampled version of a decoded level 1 stream, e.g. the output of an upsampling component 617, and the input video 600. The input to the up-sampling component 617 is generated by applying a first decoder (i.e., a level 1 decoder) to the output of the first encoder 615. This generates a decoded set of level 1 residuals. These are then combined with the output of the base decoder 614 at summation component 620. This effectively applies the level 1 residuals to the output of the base decoder 614. It allows for losses in the level 1 encoding and decoding process to be corrected by the level 2 residuals. The output of summation component 620 may be seen as a simulated signal that represents an output of applying level 1 processing to the encoded base stream 601 and the encoded level 1 stream 602 at a decoder.

As noted, an upsampled stream is compared to the input video which creates a further set of residuals (i.e., a difference operation is applied to the upsampled re-created stream to generate a further set of residuals). The further set of residuals are then encoded by a second encoder 621 (i.e., a level 2 encoder) as the encoded level 2 enhancement stream (i.e., an encoding operation is then applied to the further set of residuals to generate an encoded further enhancement stream).

Thus, as illustrated in FIG. 6 and described above, the output of the encoding process is a base stream 601 and one or more enhancement streams 602, 603 which preferably comprise a first level of enhancement and a further level of enhancement. The three streams 601, 602 and 603 may be combined, with or without additional information such as control headers, to generate a combined stream for the video encoding framework that represents the input video 600. It should be noted that the components shown in FIG. 6 may operate on blocks or coding units of data, e.g. corresponding to 2×2 or 4×4 portions of a frame at a particular level of resolution. The components operate without any inter-block dependencies, hence they may be applied in parallel to multiple blocks or coding units within a frame. This differs from comparative video encoding schemes wherein there are dependencies between blocks (e.g., either spatial dependencies or temporal dependencies). The dependencies of comparative video encoding schemes limit the level of parallelism and require a much higher complexity.

### Second Example Hierarchical Decoder & Components

A corresponding generalised decoding process is depicted in the block diagram of FIG. 7. FIG. 7 may be said to show a low complexity decoder that corresponds to the low complexity encoder of FIG. 6. The low complexity decoder receives the three streams 601, 602, 603 generated by the low complexity encoder together with headers 704 containing further decoding information. The encoded base stream 601 is decoded by a base decoder 710 corresponding to the base codec used in the low complexity encoder. The encoded level 1 stream 602 is received by a first decoder 711 (i.e., a level 1 decoder), which decodes a first set of residuals as encoded by the first encoder 615 of FIG. 1. At a first summation component 712, the output of the base decoder 710 is combined with the decoded residuals obtained from the first decoder 711. The combined video, which may be said to be a level 1 reconstructed video signal, is upsampled by upsampling component 713. The encoded level 2 stream 103 is received by a second decoder 714 (i.e., a level 2 decoder). The second decoder 714 decodes a second set of residuals as encoded by the second encoder 621 of FIG. 1. Although the headers 704 are shown in FIG. 7 as being used by the second decoder 714, they may also be used by the first decoder 711 as well as the base decoder 710. The output of the second decoder 714 is a second set of decoded residuals. These may be at a higher resolution to the first set of residuals and the input to the upsampling component 713. At a second summation component 715, the second set of residuals from the second decoder 714 are combined with the output of the up-sampling component 713, i.e. an up-sampled reconstructed level 1 signal, to reconstruct decoded video 750.

As per the low complexity encoder, the low complexity decoder of FIG. 7 may operate in parallel on different blocks or coding units of a given frame of the video signal. Additionally, decoding by two or more of the base decoder 710, the first decoder 711 and the second decoder 714 may be performed in parallel. This is possible as there are no inter-block dependencies.

In the decoding process, the decoder may parse the headers 704 (which may contain global configuration information, picture or frame configuration information, and data block configuration information) and configure the low complexity decoder based on those headers. In order to re-create the input video, the low complexity decoder may decode each of the base stream, the first enhancement stream and the further or second enhancement stream. The frames of the stream may be synchronised and then combined to derive the decoded video 750. The decoded video 750 may be a lossy or lossless reconstruction of the original input video 100 depending on the configuration of the low complexity encoder and decoder. In many cases, the decoded video 750 may be a lossy reconstruction of the original input video 600 where the losses have a reduced or minimal effect on the perception of the decoded video 750.

In each of FIGS. 6 and 7, the level 2 and level 1 encoding operations may include the steps of transformation, quantization and entropy encoding (e.g., in that order). These steps may be implemented in a similar manner to the operations shown in FIGS. 4 and 5. The encoding operations may also include residual ranking, weighting and filtering. Similarly, at the decoding stage, the residuals may be passed through an entropy decoder, a de-quantizer and an inverse transform module (e.g., in that order). Any suitable encoding and corresponding decoding operation may be used. Preferably however, the level 2 and level 1 encoding steps may be performed in software (e.g., as executed by one or more central or graphical processing units in an encoding device).

In examples described herein, the transform is a directional decomposition transform such as a Hadamard-based transform. This may involve applying a small kernel or matrix to flattened coding units of residuals (i.e. 2×2 or 4×4 blocks of residuals). More details on the transform can be found for example in patent applications WO2020188273 A1 or WO2018046941 A1, which are incorporated herein by reference. The encoder may select between different transforms to be used, for example between a size of kernel to be applied.

The transform may transform the residual information to four surfaces. For example, the transform may produce the following components or transformed coefficients: average, vertical, horizontal and diagonal. A particular surface may comprise all the values for a particular component, e.g. a first surface may comprise all the average values, a second all the vertical values and so on. As alluded to earlier in this disclosure, these components that are output by the transform may be taken as the data to be quantized. The transformation may comprise a Hadamard transformation as discussed above. In comparative examples, the average component may be adjusted using a predicted average; in the present examples, the predict average adjustment is not applied explicitly but is applied implicitly using an adjusted upsampling filter. As such, in the later described examples, the benefits of the predicted average are provided without the additional predicted average computations (e.g., as if a predicted average mode is off). A quantization scheme may be useful to create the residual signals into quanta, so that certain variables can assume only certain discrete magnitudes. Entropy encoding in this example may comprise run length encoding (RLE), then processing the encoded output is processed using a Huffman encoder. In certain cases, only one of these schemes may be used when entropy encoding is desirable.

In summary, the methods and apparatuses herein are based on an overall approach which is built over an existing encoding and/or decoding algorithm (such as MPEG standards such as AVC/H.264, HEVC/H.265, etc. as well as non-standard algorithm such as VP9, AV1, and others) which works as a baseline for an enhancement layer which works accordingly to a different encoding and/or decoding approach. The idea behind the overall approach of the examples is to hierarchically encode/decode the video frame as opposed to the use block-based approaches as used in the MPEG family of algorithms. Hierarchically encoding a frame includes generating residuals for the full frame, and then a decimated frame and so on.

As indicated above, the processes may be applied in parallel to coding units or blocks of a colour component of a frame as there are no inter-block dependencies. The encoding of each colour component within a set of colour components may also be performed in parallel (e.g., such that the operations are duplicated according to (number of frames)*(number of colour components)*(number of coding units per frame)). It should also be noted that different colour components may have a different number of coding units per frame, e.g. a luma (e.g., Y) component may be processed at a higher resolution than a set of chroma (e.g., U or V) components as human vision may detect lightness changes more than colour changes.

Thus, as illustrated and described above, the output of the decoding process is an (optional) base reconstruction, and an original signal reconstruction at a higher level. This example is particularly well-suited to creating encoded and decoded video at different frame resolutions. For example, the input signal 30 may be an HD video signal comprising frames at 1920×1080 resolution. In certain cases, the base reconstruction and the level 2 reconstruction may both be used by a display device. For example, in cases of network traffic, the level 2 stream may be disrupted more than the level 1 and base streams (as it may contain up to 4× the amount of data where down-sampling reduces the dimensionality in each direction by 2). In this case, when traffic occurs the display device may revert to displaying the base reconstruction while the level 2 stream is disrupted (e.g., while a level 2 reconstruction is unavailable), and then return to displaying the level 2 reconstruction when network conditions improve. A similar approach may be applied when a decoding device suffers from resource constraints, e.g. a set-top box performing a systems update may have an operation base decoder 220 to output the base reconstruction but may not have processing capacity to compute the level 2 reconstruction.

The encoding arrangement also enables video distributors to distribute video to a set of heterogeneous devices; those with just a base decoder 720 view the base reconstruction, whereas those with the enhancement level may view a higher-quality level 2 reconstruction. In comparative cases, two full video streams at separate resolutions were required to service both sets of devices. As the level 2 and level 1 enhancement streams encode residual data, the level 2 and level 1 enhancement streams may be more efficiently encoded, e.g. distributions of residual data typically have much of their mass around 0 (i.e. where there is no difference) and typically take on a small range of values about 0. This may be particularly the case following quantization. In contrast, full video streams at different resolutions will have different distributions with a non-zero mean or median that require a higher bit rate for transmission to the decoder.

In the examples described herein residuals are encoded by an encoding pipeline. This may include transformation, quantization and entropy encoding operations. It may also include residual ranking, weighting and filtering. Residuals are then transmitted to a decoder, e.g. as L-1 and L-2 enhancement streams, which may be combined with a base stream as a hybrid stream (or transmitted separately). In one case, a bit rate is set for a hybrid data stream that comprises the base stream and both enhancements streams, and then different adaptive bit rates are applied to the individual streams based on the data being processed to meet the set bit rate (e.g., high-quality video that is perceived with low levels of artefacts may be constructed by adaptively assigning a bit rate to different individual streams, even at a frame by frame level, such that constrained data may be used by the most perceptually influential individual streams, which may change as the image data changes).

The sets of residuals as described herein may be seen as sparse data, e.g. in many cases there is no difference for a given pixel or area and the resultant residual value is zero. When looking at the distribution of residuals much of the probability mass is allocated to small residual values located near zero—e.g. for certain videos values of −2, −1, 0, 1, 2 etc. occur the most frequently. In certain cases, the distribution of residual values is symmetric or near symmetric about 0. In certain test video cases, the distribution of residual values was found to take a shape similar to logarithmic or exponential distributions (e.g., symmetrically or near symmetrically) about 0. The exact distribution of residual values may depend on the content of the input video stream.

Residuals may be treated as a two-dimensional image in themselves, e.g. a delta image of differences. Seen in this manner the sparsity of the data may be seen to relate features like “dots”, small “lines”, “edges”, “corners”, etc. that are visible in the residual images. It has been found that these features are typically not fully correlated (e.g., in space and/or in time) They have characteristics that differ from the characteristics of the image data they are derived from (e.g., pixel characteristics of the original video signal).

As the characteristics of residuals differ from the characteristics of the image data they are derived from it is generally not possible to apply standard encoding approaches, e.g. such as those found in traditional Moving Picture Experts Group (MPEG) encoding and decoding standards. For example, many comparative schemes use large transforms (e.g., transforms of large areas of pixels in a normal video frame). Due to the characteristics of residuals, e.g. as described above, it would be very inefficient to use these comparative large transforms on residual images. For example, it would be very hard to encode a small dot in a residual image using a large block designed for an area of a normal image.

Certain examples described herein address these issues by instead using small and simple transform kernels (e.g., 2×2 or 4×4 kernels—the Directional Decomposition and the Directional Decomposition Squared—as presented herein). The transform described herein may be applied using a Hadamard matrix (e.g., a 4×4 matrix for a flattened 2×2 coding block or a 16×16 matrix for a flattened 4×4 coding block). This moves in a different direction from comparative video encoding approaches. Applying these new approaches to blocks of residuals generates compression efficiency. For example, certain transforms generate uncorrelated transformed coefficients (e.g., in space) that may be efficiently compressed. While correlations between transformed coefficients may be exploited, e.g. for lines in residual images, these can lead to encoding complexity, which is difficult to implement on legacy and low-resource devices, and often generates other complex artefacts that need to be corrected. Pre-processing residuals by setting certain residual values to 0 (i.e., not forwarding these for processing) may provide a controllable and flexible way to manage bitrates and stream bandwidths, as well as resource use.

### Examples Relating to Enhancement of Upsampling

The present invention relates to implementations of an upsampling filter. For example, approaches as described herein may be used in implementations of one or more of upsamplers 202, 522, 526, 530, 617 and 713 in FIGS. 1 to 7.

### Adapted Upsampling Filter

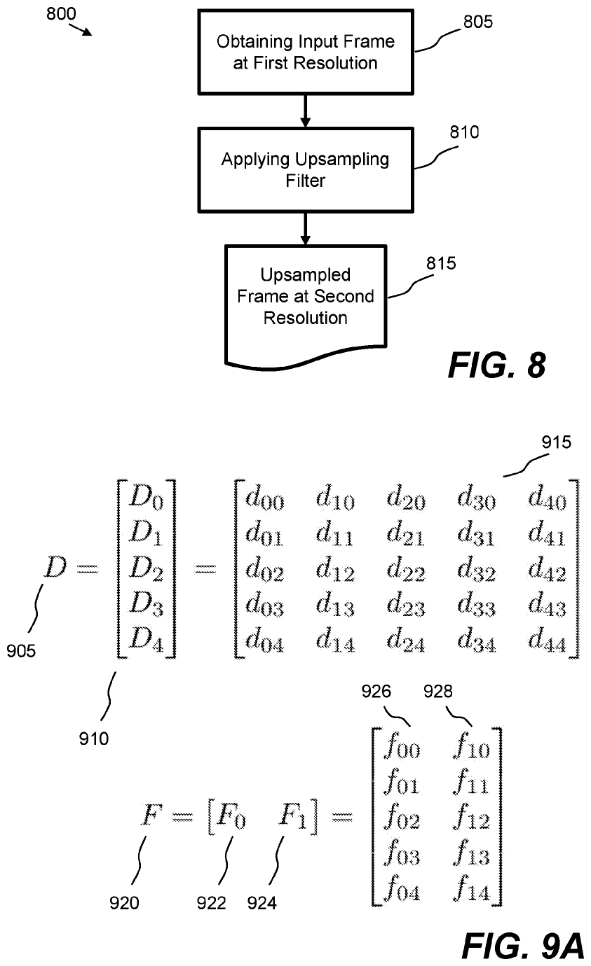

FIG. 8 shows an example method of applying an upsampling filter configured according to the present invention. At block 805, an input frame of video at a first resolution is obtained. This may be a reconstructed frame at a lower layer or tier in the above hierarchical or tier-based configurations (e.g., data 515, 520, or 528 in FIG. 5, the output of summation 620 in FIG. 6, or the output of summation 712 in FIG. 7). At block 810, an upsampling filter is applied to output an upsampled frame at a second resolution 815. This may comprise data 517 or 534 in FIG. 5, the input to residual computation 619 in FIG. 6 or the input to reconstruction summation 715 in FIG. 7.

In the present examples, the upsampling filter is configured to apply a predicted average modifier. This predicted average modifier may comprise the modifier described in WO2020/188242 A1 or the “predicted average” value described in EP 2850829 B1. In comparative examples, the predicted average modifier is derived as a difference between an average of a data block of pixels at the second resolution following application of the upsampling filter and a corresponding pixel value at the first resolution before application of the upsampling filter. For example, for a factor of 2 upsampling, each of a set of input pixels in a plane of values may be upsampled to a corresponding 2×2 block of values (with edge cases being treated differently in certain cases—e.g. with padding or clipping). The predicted average modifier modifies (e.g., reduces) an average of a data block of residuals derived as a difference between a frame of video at the second resolution following upsampling and an original frame of video at the second resolution that is used to derive an input frame of video for the upsampling. For example, a plane of residuals is generated at level 2 comparator 619 in FIG. 6 or as one of the differences 203 in FIGS. 2 and 3. Within this plane of residuals, pixel values may be grouped into n-by-n data blocks to form coding units, with n typically being 2 or 4. These n-by-n data blocks of residuals will have corresponding n-by-n data blocks within the upsampled frame, e.g., a 64×64 plane of residuals as output by level 2 comparator 619 would have 32×32 2×2 data blocks of residuals that are generated by 32×32 corresponding 2×2 data blocks in the input video 600 and the output of the upsampling 617. During level 2 encoding 621 in FIG. 6 or echelon encoding 401 in FIG. 4, each n-by-n data blocks of residuals is transformed to produce a set of n² directional components, where one of those directional components is an average component computed by summing the values in the data block. In comparative examples, e.g. as described in EP 2850829 B1, the predicted average modifier may be computed as the difference between an average of a data block of pixels at the second resolution following application of the upsampling filter and a corresponding pixel value at the first resolution before application of the upsampling filter, and then subtracted from the average of the residual values in the data block. However, by optimising the coefficients of the upsampling filter, the average of the data block of pixels at the second resolution following application of the upsampling filter may be close to (e.g., within a quantisation range) or equal to the corresponding pixel value at the first resolution such that the predicted average modifier is zero, which is equivalent to implicitly applying the predicted average.

In certain examples described herein a separable upsampling filter is provided, wherein a set of separable filter coefficients are configured to minimise a difference between an average of a data block of residuals and a predicted average for the data block of residuals. Here, the data block of residuals is derived as a difference between a frame of video at the second resolution following upsampling and an original frame of video at the second resolution that is used to derive an input frame of video for the upsampling. The filter thus applies a predicted average implicitly during the upsampling process by altering the upsampling filter coefficients (to produce a “predicted-average-preserving filter”), where the predicted average represents a difference between an average of a data block of pixels at the second resolution following upsampling and a corresponding pixel value at the first resolution before upsampling, the predicted average in comparative examples being subtracted to each data block in a “predicted average mode” during encoding and added to each data block in a “predicted average mode” during decoding. The adapted upsampling filter of examples thus provides this “predicted average mode” but without an explicit computation in addition to the upsampling operation. Or put another way, the predicted average is configured via the upsampling to have a value of 0, avoiding the need to explicitly subtract (at the encoder) or add (at the decoder) the predicted average to the data blocks.

### Example Separable Filter

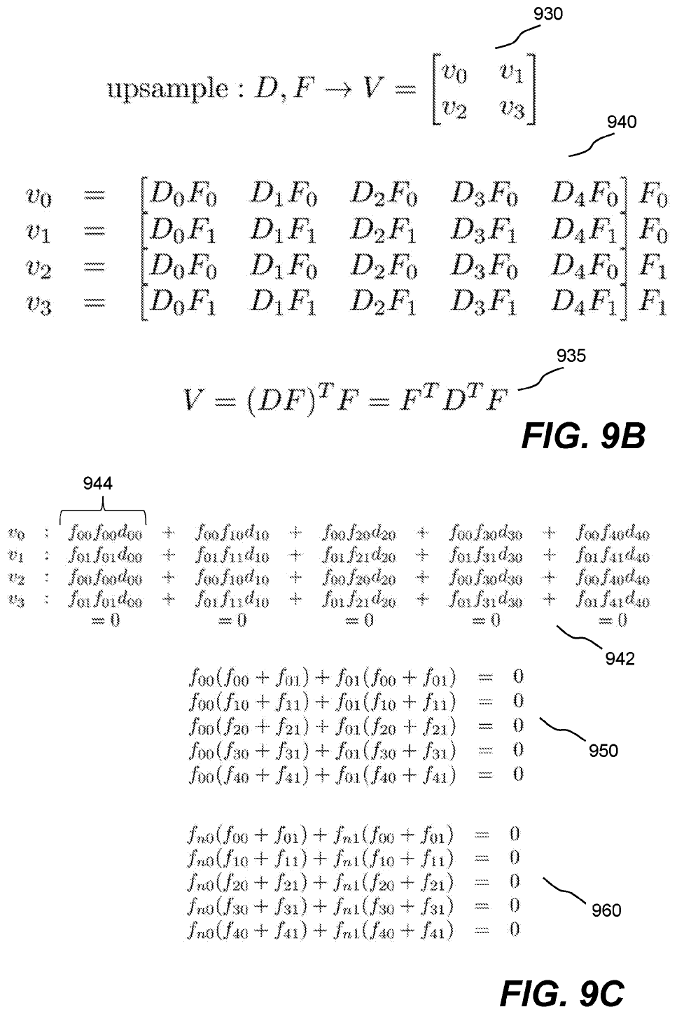

FIGS. 9A and 9B show an example separable filter that may be configured to apply a predicted average as described herein. In the example of FIGS. 9A and 9B, a five-coefficient separable filter is shown. The concept of a separable filter is known in the art: a separable filter is one in which multiple dimensions of a signal, such as the two spatial dimensions of a plane for a frame of video, are filtered in series by respective lower-dimensionality filters, such as two one-dimensional filters, where each filter is applied in a different direction. In this case, there are two one-dimensional filters each having five coefficients (i.e., a 5-tap filter).

FIG. 9A shows a receptive field 905 for one lower resolution pixel value to be upsampled—d₂₂. The receptive field 905 is a 5×5 area around the lower resolution pixel and may be represented as 5 rows of pixel values 910 or a 5×5 grid 915. The receptive field is of a 5×5 size because the two 1D five-coefficient filters effectively perform a 5×5 2D filtering. FIG. 9A also shows a definition of the example separable filter 920, which comprises a first filter 922 and a second filter 924, with the filter coefficients shown as 926 and 928. In this example a factor of two upsampling is performed such that the filter F 920 applied to the receptive field D 905 results in four output pixels shown as V 930. FIG. 9B shows how each of the four output pixels are derived from a computation involving the data rows 910 and the first and second filters 922, 924. The 2×2 grid of four output pixels 930 may thus be computed as: V=F^{T}D^{T}F where F=[F₀, F₁] and D is the receptive field. Similar computations may be applied for different length separable filters, e.g. for a three-coefficient filter, the receptive field is a 3×3 grid centred around a current pixel or for a four-coefficient filter, the receptive field is a 4×4 grid with the pixel being upsampled located at one of the four central pixels (e.g., as defined when designing the filter).

Using the above framework, an average component for a n-by-n data block may be computed as:

$$A = \frac{1}{{n}^{2}} {\sum }_{i = 0}^{{n}^{2} - 1} ( {I}_{i} - {v}_{i} ) = \overline{I} - \overline{V}$$

where I is an n-by-n data block of the input frame (e.g., 210 or 600) and vi are the elements of V—i.e. the residual average may be computed as the average of the input frame data block minus the average of the upsampled data block.

In the above examples, the input signal is downsampled and then upsampled to generate V. For example, downsampling is applied at the encoder at 201 in FIGS. 2 and 3 and at 605 in FIG. 6. The downsampling of the input signal generates the data for the receptive field D, where this data may be a reconstructed lower resolution signal following base encoding and decoding as shown in the example of FIG. 6. If we take d as the pixel value that is upsampled to generate V, we can define a difference ∂_{A} between this pixel as found in a downsampled input frame and the reconstructed pixel value d:

$${\partial }_{A} = ⋁ ( I ) - d$$

where V( . . . ) is a function that downsamples a data block derived from the input frame I. Now if the downsampling function is an average downsampler then V(I)=Ī and we can define A as:

$$A = ( d + {\partial }_{A} ) - \overline{V}$$

and as the decoder has access to d and V̅, we can define an adjusted average component as:

$${\partial }_{A} = A - ( d - \overline{V} )$$

where a predicted average is defined as:

$$PA = ( d - \overline{V} )$$

In comparative encoders, the predicted average PA is thus computed at the encoder and subtracted from the average A such that the smaller ∂_{A} is encoded in place of A for each data block. However, if the upsampling filter is configured such that the predicted average PA is zero, i.e. d=V̅, then this is the same as applying the predicted average modification implicitly as ∂_{A}=A. Thus, in the present examples the upsampling filter is configured such that:

V̅=d

For a 2-by-2 data block, this means that the filter coefficients are configured such that:

$${v}_{0} + {v}_{1} + {v}_{2} + {v}_{3} = 4 d$$

In a five-coefficient filter such as that shown in FIGS. 9A and 9B, the above equation is satisfied when all data values dₘₙ m,nϵ[0, 1, 2, 3, 4] cancel leaving the central value d₂₂. For example, FIG. 9C shows an example 942 where the Do terms in the expressions for the upsampled pixel values v, 940 in FIG. 9B are expanded. In this case, each group of terms, such as group 944, can be constrained to sum to zero. From this, a set of equalities 950 may be defined such that the terms cancel (i.e., the columns or groups 944 sum to zero). This may then be expanded from the Do case to the general Dₙ case with a set of equalities 960 as shown in FIG. 9C, where n/2. A non-trivial solution for the set of equalities 960 is a case where fₙ₀+fₙ₁=0 for n≠2. For the case where n=2, all equalities apart from the third central equality may be set as shown in 960; the third central quality may then be formulated as:

$${f}_{20} ( {f}_{20} + {f}_{21} ) + {f}_{21} ( {f}_{20} + {f}_{21} ) = 4$$

Solving for f₂₀ and f₂₁, arrives at f₂₀+f₂₁=±2. This then indicates a general solution for a five-coefficient predicted-average-preserving separable filter as:

$$F = \begin{matrix}[ {F}_{0} & {F}_{1} ]\end{matrix} = [ \begin{matrix}{f}_{0} & - {f}_{0} \\ {f}_{1} & - {f}_{1} \\ {f}_{2} & \pm 2 - {f}_{2} \\ {f}_{3} & - {f}_{3} \\ {f}_{4} & - {f}_{4}\end{matrix} ]$$

Hence, a separable filter having the form above will satisfy the constraint that the average of the upsampled data block equals the lower resolution value being upsampled.

The above solution allows for existing non-predicted-average-preserving filters to be adapted to provide a predicted-average-preserving filter. For example, a separable, five-coefficient non-predicted-average-preserving cubic upsampler may be defined as:

$${F}_{NPA} = \begin{matrix}[ {F}_{0} & {F}_{1} ]\end{matrix} = [ \begin{matrix}a & 0 \\ b & d \\ c & c \\ d & b \\ 0 & a\end{matrix} ]$$

To adapt this filter to provide a predicted-average computation implicitly, the coefficients may be adapted to confirm to the general form shown above. The coefficients shown above are thus modified as follows:

$${F}_{PA} = \begin{matrix}[ {F}_{0} & {F}_{1} ]\end{matrix} = [ \begin{matrix}a / 2 & - a / 2 \\ ( b - d ) / 2 & - ( b - d ) / 2 \\ 1 & 1 \\ - ( b - d ) / 2 & ( b - d ) / 2 \\ - a / 2 & a / 2\end{matrix} ]$$

Although the above solution provides a predicted-average-preserving filter (i.e., a filter that applies the predicted average computation implicitly), the filters described above are five-coefficient (five-tap) filters. In certain video decoders, such as set-top boxes and legacy devices, there is a limitation on the resources available to the upsampling filter. In particular, this limitation may be with respect to the number of filter coefficients that are available. For example, certain video processing devices are limited to four-coefficient filters, e.g. due to hardware constraints.

Certain video coding standards, such as LCEVC, also specify that an upsampling filter's filterbanks contains coefficients that comply with particular defined patterns, i.e. are limited to certain forms of a filter coefficients. In LCEVC, sets of filter coefficients for particular upsampling filters are specified to be of the form:

$$F = [ - a , b , … , y , - z ]$$

i.e. that the first and last coefficients need to be negative. This form of “mirrored kernel” can avoid having to send negative values in the bitstream (e.g., a and z are sent in the bitstream as positive coefficients and then automatically set to their negative counterpart at the decoder, equivalent to a*−1 and z*−1), which may improve compression and reduce complexity while allowing adaptive filters where the coefficients vary. There may also be a constraint that values of coefficients apart from the first and last coefficients are positive. In the general solution for a five-coefficient predicted-average-preserving separable filter set out above, one implementation that meets this specification would have f₀=−f₀=0 and f₄=−f₄=0. However, this would essentially reduce a five-coefficient filter to a three-coefficient filter while retaining the implementational complexity of a five-coefficient filter.

Given these additional constraints that apply for certain implementations, it is also desired to have an approximation to a predicted-average-preserving (separable) filter that has four-coefficients and has negative values for the first and last filter coefficients in each filterbank.

Turning to a four-coefficient filter, this may be specified as having the following general form:

$$F = \begin{matrix}[ {F}_{0} & {F}_{1} ]\end{matrix} = [ \begin{matrix}b & a \\ c & b \\ b & c \\ a & d\end{matrix} ]$$

This four-coefficient filter may also be specified as a five-coefficient filter, where one coefficient of each filter phase is set to 0, i.e.:

$$F = \begin{matrix}[ {F}_{0} & {F}_{1} ]\end{matrix} = [ \begin{matrix}d & 0 \\ c & a \\ b & b \\ a & c \\ 0 & d\end{matrix} ]$$

Taking this and reviewing one of the solutions for a predicted-average-applying filter, there are the constraints that:

$${f}_{n 0} + {f}_{n 1} = 0 for n \neq 2 \\ {f}_{20} + {f}_{21} = \pm 2$$

Returning to the four-coefficient filter specified as a five-coefficient filter, one solution to these constraints is for a=−c and b=±1 and for d=0. This then indicates that a general form for a four-coefficient predicted-average-applying filter may be written as:

$$F = [ \begin{matrix}{F}_{0} & {F}_{1}\end{matrix} ] = [ \begin{matrix}x & 0 \\ 1 & - x \\ - x & 1 \\ 0 & x\end{matrix} ]$$

Comparing this form and the five-coefficient F_{PA} specification above, this then suggests an approximation to the original four-coefficient filter that preserves or applies a predicted average may be defined as:

$${F}^{′} = [ \begin{matrix}{F}_{0} & {F}_{1}\end{matrix} ] = [ \begin{matrix}- ( b - d ) / 2 & 0 \\ 1 & ( b - d ) / 2 \\ ( b - d ) / 2 & 1 \\ 0 & - ( b - d ) / 2\end{matrix} ]$$

Hence, the above formulations may be used to convert a non-predicted-average-applying filter F to a predicted-average-applying filter F′ or F_{PA}.

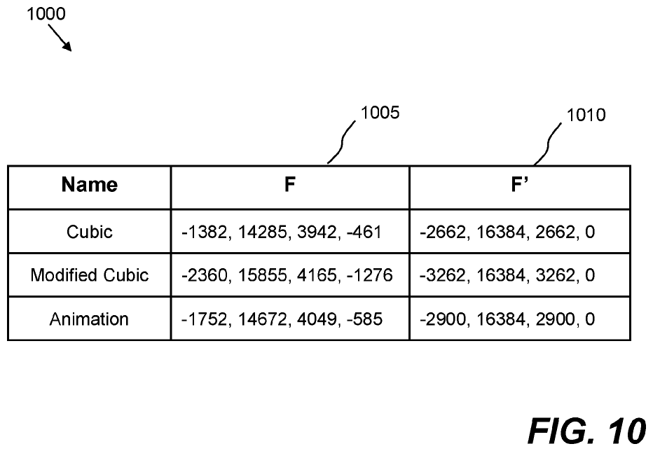

FIG. 10 shows an example 1000 of a set of four-coefficient non-predicted-average-applying filters F 1005 and their counterparts F′ 1010 that are configured according to the specification above to implicitly apply a predicted average computation. According to the derivations above, an existing four- or five-coefficient upsampling filter may thus be adapted to produce a predicted average (sometimes referred to as a predicted residual) applying upsampling filter. The predicted-average-applying filters approximate the filtering of the original filter as well as applying a predicted average. In these cases, a predicted-average-applying filter is one that if a predicted average were applied, e.g. before an inverse transformation as described in EP 2850829 B1 or as a post upsampling modifier as in WO2020/188242 A1, the predicted average (i.e., any modifier) would be zero. Hence, the upsampler acts as if the predicted average was applied, without explicitly making the predicted average correction. This is the case as the upsampler is configured to constrain an average of an upsampled data block of pixels to the corresponding pixel value prior to upsampling. The present methods allow any custom filter kernel to be easily converted into a predicted-average-applying filter, e.g. by applying the conversions shown above. By using a custom predicted-average-applying filter, the predicted average computation may be disabled within a configuration for LCEVC or VC-6, yet a predicted average computation would still be applied (even if the predicted average computation was enabled, it would have no effect as the predicted average modifier would be zero in each case).

Performing the predicted average computation implicitly via configuration of the upsampler provides benefits regardless of where processing is performed. For example, it can speed up processing on both Graphics Processing Units (GPUs) and Central Processing Units (CPUs) by reducing the number of operations that need to be performed (e.g., upsampling is performed during all encoding and decoding anyway and the present approaches do not increase the number of coefficients that are used or the number of upsampling computations). By reducing a number of operations that are performed for each data block, there may also be savings in battery power that is consumed on mobile devices (e.g., savings of around 5% of battery consumption were observed in tests).

### Training an Adapted Upsampling Filter

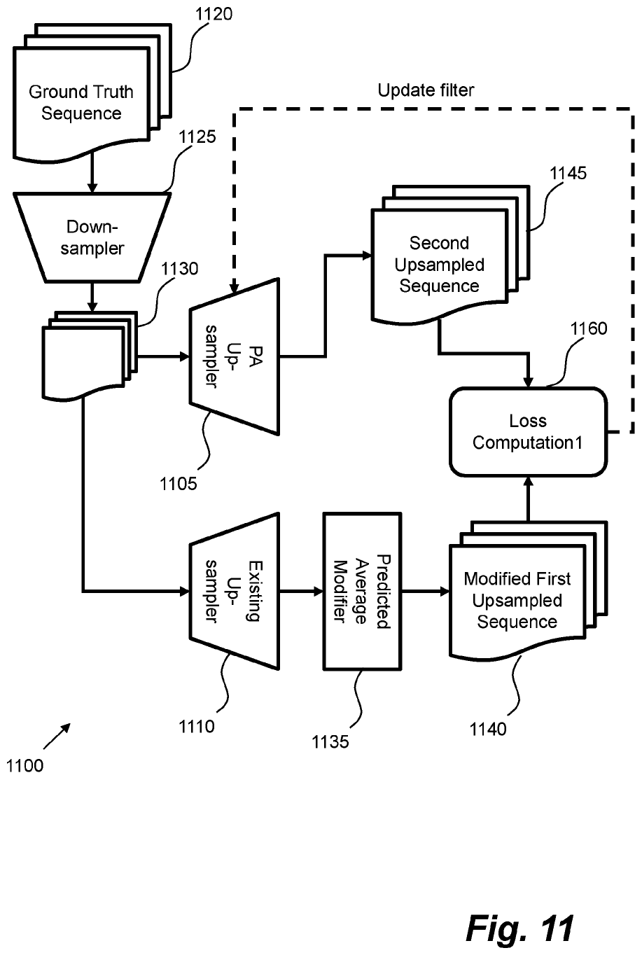

In certain cases, as described above, a set of upsampling coefficients, e.g. for a separable upsampling filter, may be selected based upon a number of constraints to implicitly apply a predicted average computation. In other cases, coefficients for an adapted upsampling filter that applies a predicted average may also be trained or optimised. FIG. 11 shows one example configuration of how this may be achieved. For example, the upsampler may be implemented as a neural network upsampler, such as a convolutional neural network.

FIG. 11 shows a training set-up 1100 where a trainable predicted-average-applying upsampler 1105 may be trained to mimic the operation of an existing non-predicted-average-applying upsampler 1110. The trainable upsampler 1105 may be any linear or non-linear upsampling filter, including separable and non-separable filters. The trainable upsampler 1105 may be implemented as a convolutional neural network with one or more filters, each filter having a set of trainable filter parameters. The existing upsampler 1110 may be any known upsampling filter, again including linear and non-linear filters, and may be separable or non-separable. In one case, the existing upsampler 1110 may comprise a known n-coefficient separable filter in the form of the (non-predicted-average-applying) five and four coefficient filters described above. In other cases, the existing upsampler 1110 may comprise a trained neural network sampler. In this case, the existing upsampler 1110 may have been previously trained to upsample a downsampled sequence in order to match as closely as possible an original input ground-truth sequence at the upsampled resolution. When training, any trainable coefficients of the existing upsampler 1110 are fixed or frozen—these coefficients are not trained or updated. Instead, the aim of the training is to configure the trainable coefficients of the trainable upsampler 1105.

In the training set-up 1100, a ground truth video sequence 1120 is obtained. The ground truth sequence 1120 may be a set of frames (e.g., one or more of luma and chroma planes) for a video sequence. The video sequence may be selected to feature a wide range of video characteristics so as to provide robust training (e.g., both static and dynamic scenes with a variety of textures). In the training set-up 1100, a downsampler 1125 is used to downsample the ground truth sequence of video frames 1120 to obtain a downsampled sequence of video frames 1130. This may be performed frame by frame or in batches. The downsampled sequence of video frames 1130 are then passed to each of the trainable upsampler 1105 and the existing upsampler 1110 for upsampling. The existing upsampler 1110 upsamples the downsampled sequence of video frames 1130 using an upsampling filter with a set of fixed coefficients to generate a first upsampled sequence. Following this a predicted average modifier 1135 is applied. For example, the predicted average modifier 1135 may be computed as a difference between the element values of an upsampled data block and an input downsampled element, e.g. as described in WO2020/188242 A1. Following modification with the predicted average at block 1135, a modified first upsampled sequence 1140 is obtained. Again, this sequence may be generated frame-by-frame or in batches.

In parallel with the upsampling and modification performed by the existing upsampler 1110 and the predicted average modifier 1135, the trainable upsampler 1105, in a forward pass or inference mode, also upsamples the downsampled sequence of video frames 1130 to generate a second upsampled sequence 1145. The modified first upsampled sequence of video frames 1140 and the second upsampled sequence of video frames 1145 are then compared as part of a loss computation 1160 to determine updates for the trainable upsampler 1105. For example, the coefficient values of the trainable upsampler 1105 may be updated using gradient descent (in known forms such as using stochastic gradient descent) and back-propagation. As part of the training, the trainable coefficients of the trainable upsampler 1105 are optimised so as to minimise the difference between the two sequences of video frames 1140, 1145 (i.e., the loss). The trainable upsampler 1105 thus learns to mimic the action of the existing upsampling 1110 and the predicted average modifier 1135, i.e. is trained to be a predicted-average-applying upsampler. In the training set-up 1100 shown in FIG. 11, the trainable upsampler 1105 is thus optimised to reconstruct a lossy version of the ground truth sequence 1120 that has itself been downsampled, upsampled and had a predicted average applied.

The adapted upsampling filters as described herein may be implemented as hardware and/or software filters. For example, custom coefficients may be loaded into application-specific upsampler filterbanks present in devices such as set-top boxes or embedded devices (e.g., via firmware updates or the like). In devices such as personal computers and mobile devices, filtering may be performed using computer program code. In this case, a memory may store a set of filter coefficients as described here, such as a set of separable filter coefficients comprising a first set of filter coefficients for filtering in a first direction and a second set of filter coefficients for filtering in a second direction, and a processor such as a CPU and/or GPU may apply the set of filter coefficients to upsample an input frame of video from a first resolution to a second resolution, the second resolution being higher than the first resolution.

One benefit of using a predicted-average-applying filter as described above, e.g. either as configured according to the specifications above or as optimised as shown in FIG. 11, is that the advantages of the predicted average computation may be obtained even when hardware limitations of a decoding device prevent the predicted average computation from being explicitly performed. For example, certain legacy devices such as set-top boxes have a limited number of possible decoding configurations and while these may be able to support custom upsampling filter coefficients and the LCEVC decoding pipelines, they may not be able to support the predicted average computation (e.g., as applied before an inverse transformation or as a modifier to be added after upsampling). The present examples thus allow a predicted average to be applied in these cases.

The above examples are to be understood as illustrative. Further examples are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A method of decoding image data, comprising:
receiving first image data at a first resolution, the first image data being associated with a frame of video;
upsampling the first image data to produce second image data for the frame of video at a second resolution, the second resolution being higher than the first resolution;
receiving encoded residual data at the second resolution, the encoded residual data comprising a plurality of encoded data blocks, an encoded data block comprising one or more directional components and at least one component derived from an average of the residual data within the encoded data block;
applying an inverse directional decomposition to data blocks of the encoded residual data to derive decoded residual data; and
combining the decoded residual data with the second image data to generate an output for the frame of video at the second resolution,
wherein the at least one component derived from an average of the residual data within the encoded data block is computed as an average component of a data block of unencoded residual data that is adjusted using a predicted average, the predicted average being derived from a pixel value in the first image data and an average of a corresponding data block of pixels within the second image data, the corresponding data block being derived from an upsampling of the pixel value in the first image data, and
wherein the upsampling comprises applying a set of upsampling coefficients selected to constrain the average of the data block of pixels in the second image data to the corresponding pixel value in the first image data so as to apply the predicted average during the upsampling.

2. The method of claim 1, wherein the upsampling comprises applying a separable filter having less than five coefficients for each of the two image dimensions.

3. The method of claim 2, wherein the set of upsampling coefficients have the following form:
$${F}_{PA} = [ \begin{matrix}{F}_{0} & {F}_{1}\end{matrix} ] = [ \begin{matrix}x & 0 \\ 1 & - x \\ - x & 1 \\ 0 & x\end{matrix} ]$$

4. The method of claim 3, wherein, for a separable upsampling filter having the form:
$$F = [ \begin{matrix}{F}_{0} & {F}_{1}\end{matrix} ] = [ \begin{matrix}d & a \\ c & b \\ b & c \\ a & d\end{matrix} ]$$
the set of upsampling coefficients are determined as:
$${F}_{PA} = [ \begin{matrix}{F}_{0} & {F}_{1}\end{matrix} ] = [ \begin{matrix}- ( b - d ) / 2 & 0 \\ 1 & ( b - d ) / 2 \\ ( b - d ) / 2 & 1 \\ 0 & - ( b - d ) / 2\end{matrix} ]$$

5. The method of claim 1, wherein the upsampling comprises applying a separable filter having five coefficients for each of the two image dimensions.

6. The method of claim 5, wherein the set of upsampling coefficients have the following form:
$${F}_{PA} = [ \begin{matrix}{F}_{0} & {F}_{1}\end{matrix} ] = [ \begin{matrix}{f}_{0} & - {f}_{0} \\ {f}_{1} & - {f}_{1} \\ {f}_{2} & \pm 2 - {f}_{2} \\ {f}_{3} & - {f}_{3} \\ {f}_{4} & - {f}_{4}\end{matrix} ]$$

7. The method of claim 6, wherein, for a separable upsampling filter having the form:
$$F = [ \begin{matrix}{F}_{0} & {F}_{1}\end{matrix} ] = [ \begin{matrix}a & 0 \\ b & d \\ c & c \\ d & b \\ 0 & a\end{matrix} ]$$
the set of upsampling coefficients are determined as:
$${F}_{PA} = [ \begin{matrix}{F}_{0} & {F}_{1}\end{matrix} ] = [ \begin{matrix}a / 2 & - a / 2 \\ ( b - d ) / 2 & - ( b - d ) / 2 \\ 1 & 1 \\ - ( b - d ) / 2 & ( b - d ) / 2 \\ - a / 2 & a / 2\end{matrix} ]$$

8. The method of claim 1, wherein the method of decoding image data applies one of Low Complexity Enhanced Video Coding (LCEVC) or SMPTE VC-6 2117.

9. The method of claim 1, wherein the set of coefficients are determined according to a training procedure with a set of applied constraints.

10. A method of encoding image data, comprising:
receiving first image data at a first resolution, the first image data being associated with an original frame of video;
upsampling the first image data to produce second image data for the frame of video at a second resolution, the second resolution being higher than the first resolution;
generating residual data at the second resolution as a difference between the second image data and the original frame of video, the residual data comprising a plurality of data blocks; and
transforming the plurality of data blocks to generate a plurality of encoded data blocks, an encoded data block comprising one or more directional components and at least one component derived from an average of the residual data within the data block being encoded, wherein the upsampling comprises applying a set of upsampling coefficients selected to constrain an average of a data block of pixels in the second image data to a corresponding pixel value in the first image data,
wherein the upsampling modifies the second image data to adjust the average of the residual data within an encoded data block, the average being adjusted using a predicted average, the predicted average representing a difference between the average of the data block of pixels in the second image data and the corresponding pixel value in the first image data.

11. The method of claim 10, wherein the upsampling comprises applying a separable filter having less than five coefficients for each of the two image dimensions.

12. The method of claim 11, wherein the set of upsampling coefficients have the following form:
$${F}_{PA} = [ \begin{matrix}{F}_{0} & {F}_{1}\end{matrix} ] = [ \begin{matrix}x & 0 \\ 1 & - x \\ - x & 1 \\ 0 & x\end{matrix} ]$$

13. The method of claim 12, wherein, for a separable upsampling filter having the form:
$$F = [ \begin{matrix}{F}_{0} & {F}_{1}\end{matrix} ] = [ \begin{matrix}d & a \\ c & b \\ b & c \\ a & d\end{matrix} ]$$
the set of upsampling coefficients are determined as:
$${F}_{PA} = [ \begin{matrix}{F}_{0} & {F}_{1}\end{matrix} ] = [ \begin{matrix}- ( b - d ) / 2 & 0 \\ 1 & ( b - d ) / 2 \\ ( b - d ) / 2 & 1 \\ 0 & - ( b - d ) / 2\end{matrix} ]$$

14. The method of claim 10, wherein the upsampling comprises applying a separable filter having five coefficients for each of the two image dimensions.

15. The method of claim 14, wherein the set of upsampling coefficients have the following form:
$${F}_{PA} = [ \begin{matrix}{F}_{0} & {F}_{1}\end{matrix} ] = [ \begin{matrix}{f}_{0} & - {f}_{0} \\ {f}_{1} & - {f}_{1} \\ {f}_{2} & \pm 2 - {f}_{2} \\ {f}_{3} & - {f}_{3} \\ {f}_{4} & - {f}_{4}\end{matrix} ]$$

16. The method of claim 15, wherein, for a separable upsampling filter having the form:
$$F = [ \begin{matrix}{F}_{0} & {F}_{1}\end{matrix} ] = [ \begin{matrix}a & 0 \\ b & d \\ c & c \\ d & b \\ 0 & a\end{matrix} ]$$
the set of upsampling coefficients are determined as:
$${F}_{PA} = [ \begin{matrix}{F}_{0} & {F}_{1}\end{matrix} ] = [ \begin{matrix}a / 2 & - a / 2 \\ ( b - d ) / 2 & - ( b - d ) / 2 \\ 1 & 1 \\ - ( b - d ) / 2 & ( b - d ) / 2 \\ - a / 2 & a / 2\end{matrix} ]$$

17. The method of claim 10, wherein the method of encoding image data applies one of Low Complexity Enhanced Video Coding (LCEVC) or SMPTE VC-6 2117.

18. The method of claim 10, wherein the set of coefficients are determined according to a training procedure with a set of applied constraints.

19. A method of training a set of coefficients for an upsampling filter, comprising:
obtaining a ground truth sequence of video frames;
downsampling the ground truth sequence of video frames to obtain a downsampled sequence of video frames;
upsampling the downsampled sequence of video frames using a first upsampling filter with a set of fixed coefficients to generate a first upsampled sequence;
applying a predicted average modifier to data derived from the first upsampled sequence to output a modified first upsampled sequence, the predicted average modifier representing a difference between the average of the data block of pixels in the first upsampled sequence and the corresponding pixel value in the downsampled sequence of video frames;
upsampling the downsampled sequence of video frames using a second upsampling filter with a set of trainable coefficients to generate a second upsampled sequence;
computing a loss between the second upsampled sequence and the modified first upsampled sequence; and
optimising the set of trainable coefficients to reduce the loss,
wherein the optimised set of trainable coefficients provide a predicted-average preserving version of the first upsampling filter.

20. (canceled)

21. (canceled)
